(19) United States
(12) Patent Application Publication
(10) Pub. No.: US 2008/0177886 A1
(43) Pub. Date: Jul. 24, 2008

(54) METHOD AND SYSTEM FOR CONNECTION SETUP IN WIRELESS COMMUNICATIONS

(75) Inventors: Harkirat Singh, Santa Clara, CA (US); Huai-Rong Shao, Santa Clara, CA (US); Xiangping Qin, San Jose, CA (US); Chiu Ngo, San Francisco, CA (US)

Correspondence Address: MYERS DAWES ANDRAS & SHERMAN, LLP, 19900 MACARTHUR BLVD., SUITE 1150, IRVINE, CA, 92612, US

(73) Assignee: Samsung Electronics Co., Ltd.

(21) Appl. No.: 12/014,719

(22) Filed: Jan. 15, 2008

Related U.S. Application Data
(60) Provisional application No. 60/881,444, filed on Jan. 19, 2007.

(51) Int. Cl. G06F 15/16

(52) U.S. Cl. 709/228

(57) ABSTRACT

A method and system for fast connection setup for wireless communication is provided. The connection setup involves establishing a connection by reserving a wireless data channel for data communication; upon completion of said data communication, maintaining the data channel reserved while indicating the data channel is unoccupied; and while the data channel remains reserved and unoccupied, establishing another connection for data communication by maintaining the data channel reserved and indicating that the data channel is occupied.

### RELATED APPLICATION

This application claims priority from U.S. Provisional Patent Application Ser. No. 60/881,444 filed on Jan. 19, 2007, incorporated herein by reference.

### FIELD OF THE INVENTION

The present invention relates to wireless communications, and in particular to establishing connections between wireless stations.

### BACKGROUND OF THE INVENTION

With the proliferation of wireless communication protocols, many wireless stations are in use in wireless networks. Such wireless stations can communicate over channels in infrastructure mode, ad hoc mode or other modes. In infrastructure mode, a wireless access point (AP) provides a coordination function by forwarding data and control messages for the wireless stations.

In ad hoc mode communication, an access point is not required. A pair of wireless stations directly establishes a connection without association to a coordinator. Establishing such a connection is achieved by signaling to reserve a data channel. Signaling includes communicating control messages, such as beacons, over a default control channel between the pair of stations.

Both in infrastructure mode and ad hoc mode communication, when connections between wireless stations need to be established in rapid succession, exchange of control message for reserving a data channel can cause a processing bottleneck and waste of bandwidth.

### BRIEF SUMMARY OF THE INVENTION

The present invention provides a method and a system for connection setup in wireless communication. One embodiment involves establishing a wireless connection by reserving a wireless data channel for data communication; upon completion of said data communication, maintaining a selected data channel reserved and indicating the data channel is unoccupied. While the data channel remains reserved and unoccupied, another wireless connection may be established for data communication on the data channel, by maintaining the data channel reserved and indicating that the data channel is occupied.

As such, said other connection can be established without expending time (or using channel bandwidth) in reserving the data channel again. This enables establishing rapid reconnection between wireless stations for successive data channel transmissions on the same reserved data channel.

These and other features, aspects and advantages of the present invention will become understood with reference to the following description, appended claims and accompanying figures.

### BRIEF DESCRIPTION OF THE DRAWINGS

FIG. 1 shows a functional block diagram of a wireless network that implements a wireless communication process for connection setup, according to an embodiment of the present invention.

FIG. 2 shows an example communication configuration among multiple wireless stations, according to the present invention.

FIG. 3 shows a wireless communication configuration involving wireless stations for ad hoc mode communication according to an embodiment of the present invention.

FIGS. 4A-B shows flowcharts of the steps of example connection setup processes for establishing rapid reconnection between wireless stations, according to the present invention.

FIG. 5 shows a wireless communication configuration involving wireless stations and a coordinator for infrastructure communication according to an embodiment of the present invention.

FIG. 6 shows an example block diagram for architecture of a wireless station implementing connection setup for rapid reconnection between wireless stations, according to the present invention.

### DETAILED DESCRIPTION OF THE INVENTION

The present invention provides a method and a system for connection setup in wireless communication. One embodiment involves establishing a connection by reserving a wireless data channel for data communication between a pair of wireless stations; upon completion of said data communication, maintaining a selected data channel reserved while indicating the data channel is unoccupied; and while the data channel remains reserved and unoccupied, establishing another connection for data communication by maintaining the data channel reserved and indicating that the data channel is occupied. As such, said other connection can be established without expending time (or using channel bandwidth) in reserving the data channel again. This enables establishing rapid reconnection between wireless stations for successive data channel transmissions on the same reserved data channel.

In one implementation, the data channel is reserved by an exchange of control messages between the stations on a control channel. As such, a wireless station has a first transceiver, such as a control channel transceiver, and a second transceiver, such as a data channel transceiver. The control channel transceiver is utilized for communication on a wireless control channel and the data channel transceiver is used for communication on a wireless data channel. The connection setup process involves using the control channel for communication of control information to facilitate reserving the data channel for establishing connections for data communication.

In one implementation, the control channel transceiver comprises a control communication module configured for communicating control information on the control channel, and the data channel transceiver comprises a data communication module configured for data communication on the data channel. The data channel can comprise a wireless in-band channel and the control channel can also comprise a wireless in-band channel.

Alternatively, the data channel can comprise a wireless in-band channel and the control channel can comprise a wireless out-of-band channel. An out-of-band channel is a first physical channel that is out-of-band relative to a second physical channel (i.e., an in-band channel). The out-of-band channel is at a frequency different from an in-band channel. For example, an in-band data transmission channel may operate on a 60 GHz frequency band, whereas, an out-of-band channel may operate on WLAN, Bluetooth, 5 GHz or 2.4 GHz (or even another 60 GHz) frequency band. An out-of-band frequency means a different frequency than an in-band frequency, even if both are in the same frequency band.

As those skilled in the art recognize, the present invention is equally applicable to a case when the data channel and the control channel are both in-band channels and to a case when the data channel is in-band and the control channel is out-of-band. In both cases, the connection setup process involves using the control channel for communication of control information to facilitate establishing a connection on the data channel. The latter case is described as an example of the present invention, wherein the control communication module comprises an out-of-band communication module configured for communicating control information on an out-of-band channel. Further, a data communication module comprises an in-band communication module configured for data communication on an in-band channel. The connection setup process involves using the out-of-band channel for communication of control information to facilitate establishing a connection on the in-band channel.

The present invention is applicable to high throughput wireless communications, such as ECMA standards on millimeter wave (mmWave) communication networks, and implementation of WirelessHD standard on uncompressed video trasmission. An example implementation for a 60 GHz frequency band wireless network is described below, useful with ECMA and WirelessHD (WiHD) applications. ECMA is an international organization providing ECMA-60 GHz wireless protocol. WirelessHD is an industry-led effort to define a wireless digital network interface specification for wireless HD digital signal transmission on the 60 GHz frequency band, e.g., for consumer electronics (CE) and other electronic products. An example WiHD network utilizes a 60 GHz-band mmWave technology to support a physical (PHY) layer data transmission rate of multi-Gbps (gigabits per second), and can be used for transmitting uncompressed high definition television (HDTV) signals wirelessly. The present invention is useful with other wireless communication systems as well.

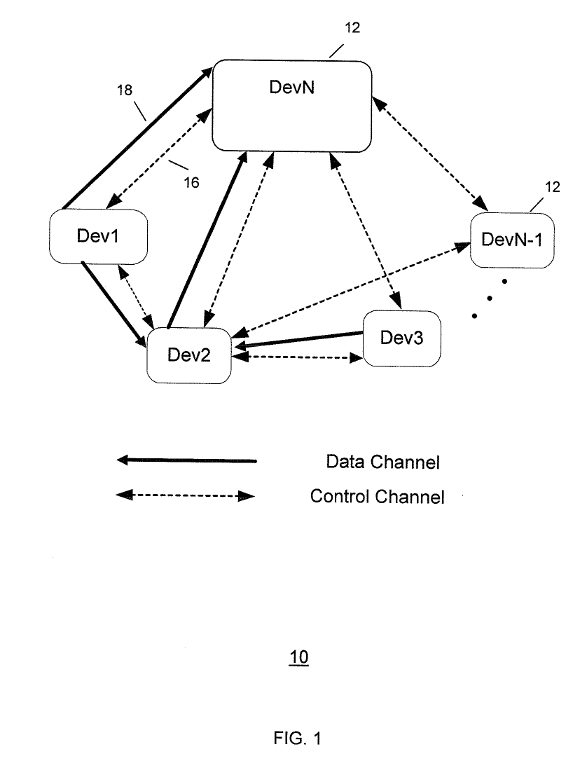

FIG. 1 shows a functional block diagram of a wireless network 10 that implements wireless communication between N wireless stations 12 (e.g., devices Dev1, . . . , DevN-1) on a 60 GHz frequency band using Frequency Division Duplex (FDD) channel access, according to an embodiment of the present invention. An out-of-band channel 16 is omni-directional and is used for control message transmissions to coordinate data transmissions on the directional in-band data channel 18 (e.g., 60 GHz). The out-of-band channel 16 can use different technologies such as Bluetooth, WLAN, other wireless technologies such as UWB, or even another different 60 GHz channel (e.g., same bandwidth or narrower than channel 18). The out-of-band channel 16 is a symmetric channel and supports a half-duplex mode. The out-of-band channel 16 has the same coverage range as the in-band data channel 18. The data channel 18 is an asymmetric channel (e.g., 60 GHz data transmission is for one-way transmission only). The channel 16 may be a default channel for control messages for all of the stations. Not all stations are required to support an in-band data channel.

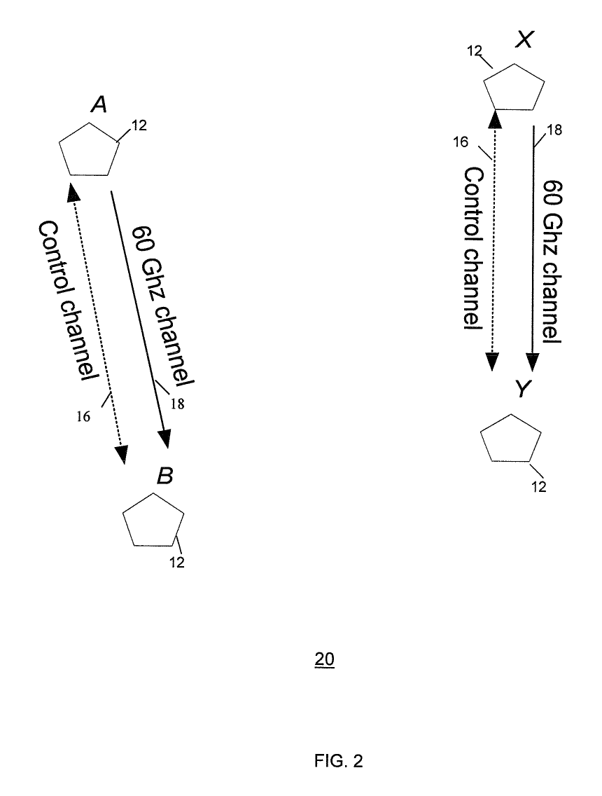

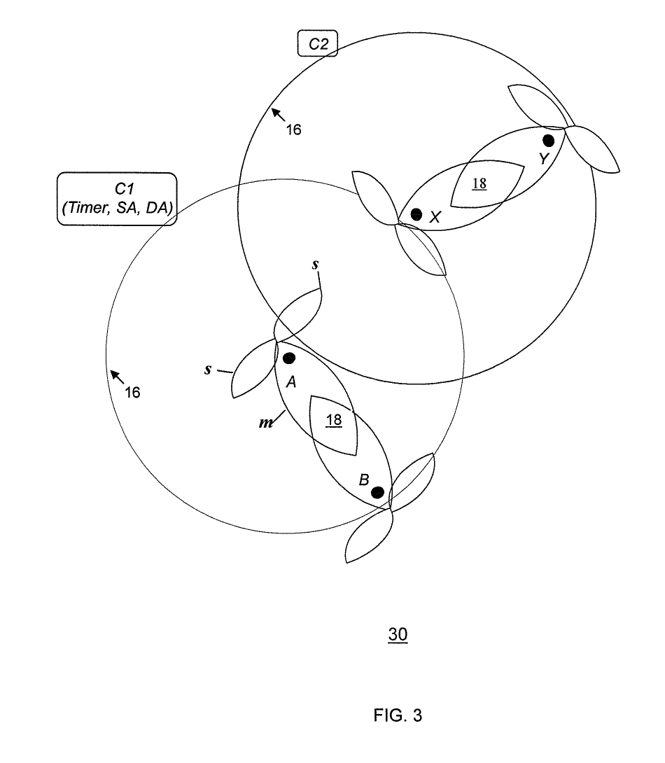

FIG. 2 shows an example communication configuration in a network 20 including wireless stations 12 (e.g., stations A, B, X and Y), according to the present invention. The stations 12 use an out-of-band channel (omni-directional control channel) 16 and an in-band channel (directional data transmission channel) 18 such as a 60 GHz channel as shown. The stations 12 can function as an initiator or a responder, wherein a transmission initiator is a station that first initiates transmission and can be a transmission sender or receiver. A transmission responder is a station that responds to the transmission initiator and can be a transmission sender or receiver. A frame structure is used for data transmission between wireless stations. For example, frame aggregation can be used in a Media Access Control (MAC) layer and a PHY layer. The MAC layer obtains a MAC Service Data Unit (MSDU) and attaches a MAC header thereto, in order to construct a MAC Protocol Data Unit (MPDU), for transmission. The MAC header includes information such as a source address (SA) and a destination address (DA). The MPDU is a part of a PHY Service Data Unit (PSDU) and is transferred to a PHY layer in the transmitter to attach a PHY header (i.e., PHY preamble) thereto to construct a PHY Protocol Data Unit (PPDU). The PHY header includes parameters for determining a transmission scheme including a coding/modulation scheme. Before transmission as a packet from a transmitter to a receiver, a preamble is attached to the PPDU, wherein the preamble can include channel estimation and synchronization information.

A first wireless station having established and used a data channel connection (e.g., 60 GHz channel) for data communication (e.g., video) with a second wireless station, may wish to reestablish another connection with the second wireless station or a third wireless station using that same data channel. Generally, prior to starting a 60 GHz connection, control messages are exchanged between wireless stations for reserving a 60 GHz channel (the specific control message exchange depends on whether the first wireless station is operating in ad hoc or infrastructure mode). However, in scenarios where connections such as 60 GHz connections are established in rapid succession, such control message exchanges to reserve a 60 GHz channel can become quite a bottleneck and waste bandwidth. The present invention provides a connection setup process that allows establishing a rapid reconnection between stations for successive data channel transmissions on a reserved data channel, without expending time (or using channel bandwidth) in reserving the data channel again.

FIG. 3 shows a wireless communication configuration 30 involving wireless stations A, B, X and Y (e.g., station 12 in FIG. 1), wherein stations A and B initially reserve a data channel 18 (e.g., 60 GHz data channel) via control message exchange on the omni-directional control channel 16 in ad hoc mode. The stations A and B use the particular 60 GHz data channel for data communication using directional signaling (directional beams on the data channel 18 comprise main lobes m and side lobes s). FIG. 3 represents an example according to the present invention, wherein after the station A finishes a 60 GHz transmission with the station B on the particular 60 GHz data channel, the station A keeps transmitting a control message, C1, on the control channel, indicating that the particular 60 GHz data channel is not busy (i.e., not occupied by data transmission) but reserved for future use.

Such a control message C1 from a wireless station (e.g., station A) can have a source MAC address (SA) and a destination MAC address (DA) of the peer station (e.g., station B) with which the data transmission on the particular 60 GHz data channel recently occurred. Optionally, the destination address may be avoided or set to the broadcast address. The control message C1 further includes a Timer field indicating the time period the particular 60 GHz data channel is reserved for future use. Before the expiry of the Timer, the station A transmits another control message C1 to renew or extend the reservation period.

In the meantime, in one scenario, if the station A needs to start another 60 GHz connection with the station B, then the station A may change the control message type to C2 (i.e., transmit another control message type, C2, on the control channel) to indicate that said particular 60 GHz data channel is busy (i.e., occupied by data transmission), such that the station A can start a 60 GHz communication with the station B on that particular 60 GHz data channel, without expending time (or using channel bandwidth) in reserving the 60 GHz data channel again. This enables establishing rapid reconnection between stations for successive data channel transmissions. The control messages C1 and C2 can also be of the same type, but have differing field values that differentiate them.

In another scenario, while the station A is still transmitting control message C1, the station X may wish to start transmitting data to the station Y on a 60 GHz data channel. Upon receiving a control message C1, the station X transmits a control message C2 on the control channel indicating that the particular 60 GHz data channel (the same channel as used recently by stations A and B) is busy and reserved (i.e., occupied) for transmissions by the station X. Upon receiving such a control message C2, the station A ceases transmitting the control messages C1. The control message C2 can include the same type of information (e.g., Timer, SA, DA) as a control message C1.

When a data channel is indicated as busy (i.e., occupied) for a pair of stations, other stations wait until the data channel is indicated as not busy, before attempting to communicate on that data channel. Though in the example above the station A (sender) is indicated as transmitting the control message C1, in other examples, either the station A or the station B (receiver), or both, can transmit the control messages C1.

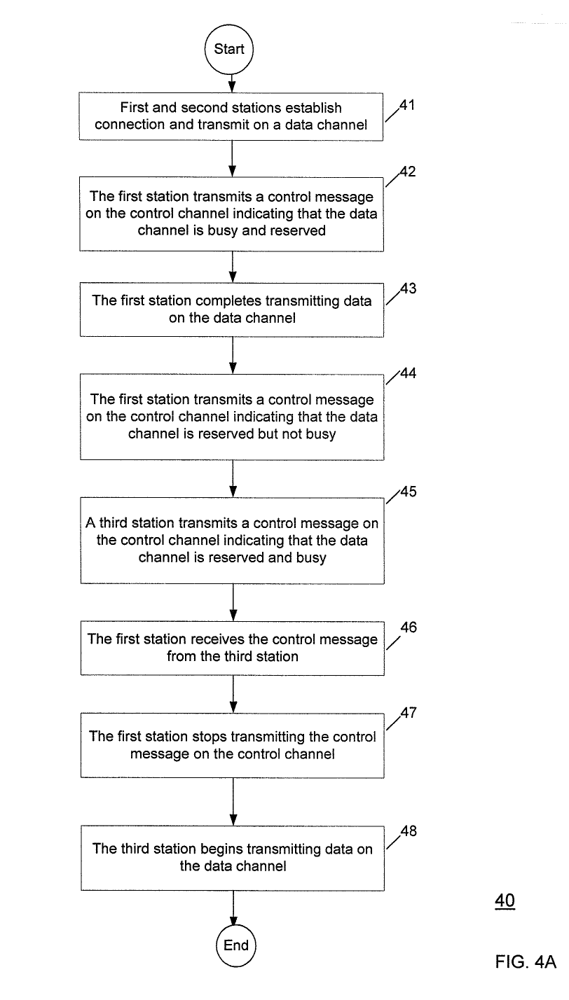

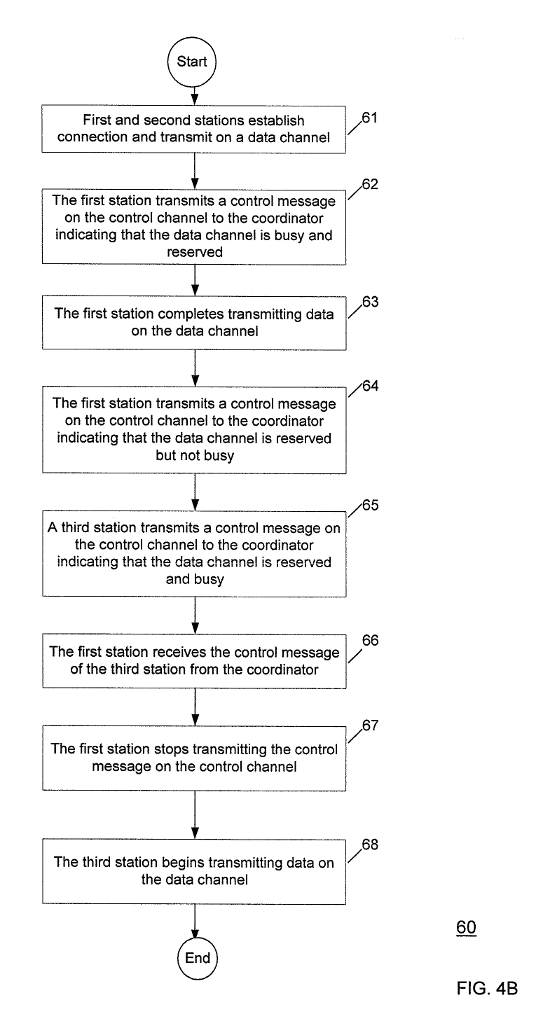

FIG. 4A shows a flowchart of the steps of an example connection setup process 40 for establishing a rapid (fast) reconnection between stations, according to the present invention, including:
Step 41: A first station and a second station have established a connection by messaging on a control channel 16 to reserve a channel 18, and are involved in data communication therebetween on the reserved data channel 18 (e.g., 60 GHz channel).
Step 42: The first station (repeatedly) transmits a control message on the control channel indicating that the data channel is busy and reserved.
Step 43: The first station completes transmitting data on the data channel.
Step 44: The first station (repeatedly) transmits a control message (e.g., C1) on the control channel indicating that the data channel is reserved but not busy.
Step 45: A third station, wishing to communicate on the data channel, upon receiving the control message (e.g., C1) from the first station, (repeatedly) transmits a control message (e.g., C2) on the control channel indicating that the data channel is reserved and busy.
Step 46: The first station receives the control message from the third station, and may optionally transmit an acknowledgment (ACK) to the third station on the control channel.
Step 47: The first station stops transmitting the control message (e.g., C1) on the control channel.
Step 48: The third station begins transmitting data on the data channel.

In steps 45-48, the third station may indeed be the first station itself wishing to communicate on the data channel again. In that case, steps 46 and 47 are unnecessary, wherein in step 45 the first station transmits a control message (e.g., C2) on the control channel indicating that the data channel is reserved and busy, and in step 48 the first station begins transmitting data on the data channel again.

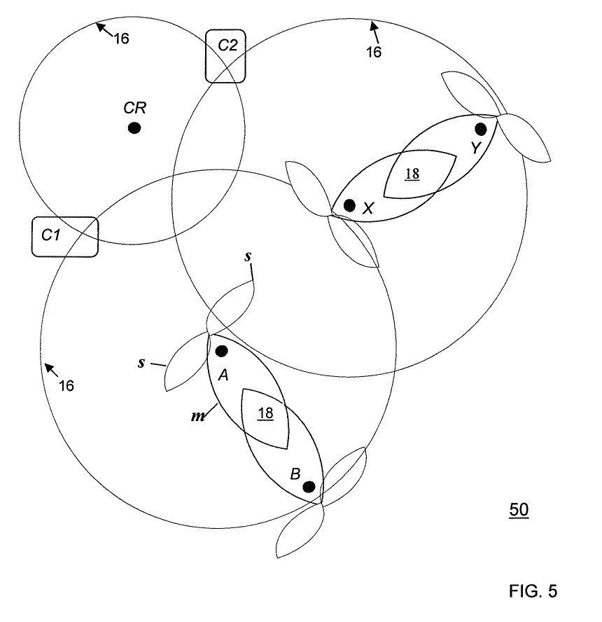

FIG. 5 shows a wireless communication configuration 50 similar to that in FIG. 3, involving said wireless stations A, B, X, Y, and additionally including a coordinator CR. The stations A and B initially reserve a data channel 18 (e.g., a 60 GHz data channel) by control message exchange via the coordinator CR in infrastructure mode, on the omni-directional control channel 16. The coordinator CR can be a wireless station such as station 12 in FIG. 1 which provides coordination functions for data channel reservation in infrastructure mode. In this example, the control messages C1 and C2 can be transmitted by the coordinator CR upon receiving additional control messages from stations A and X. These additional messages for example can be messages from station A indicating that the data channel is reserved but unoccupied, and another message from station X indicating that station X needs to reserve the data channel for transmission. So then the coordinator transmits a certain message (beacon) indicating that the data channel is reserved by station X and occupied, or the data channel is reserved by station A and unoccupied, depending on the scenario.

Referring to the example process 60 in FIG. 4B for infrastructure mode, the process 40 in FIG. 4A is modified such that the control messages C1, C2 are handled by the coordinator. The stations sending the control messages C1, C2, signal to the coordinator and the coordinator handles reservations. The process 60 includes the following steps:
Step 61: A first station and a second station have established a connection by messaging a coordinator on a control channel 16 to reserve a channel 18, and are involved in data communication therebetween on the reserved data channel 18 (e.g., 60 GHz channel).
Step 62: The first station (repeatedly) transmits a control message on the control channel to the coordinator indicating that the data channel is busy and reserved.
Step 63: The first station completes transmitting data on the data channel.
Step 64: The first station (repeatedly) transmits a control message (e.g., C1) on the control channel to the coordinator indicating that the data channel is reserved but not busy.
Step 65: A third station, wishing to communicate on the data channel, upon receiving the control message (e.g., C1) from the coordinator, (repeatedly) transmits a control message (e.g., C2) on the control channel to the coordinator indicating that the data channel is reserved and busy.
Step 66: The first station receives the control message (e.g., C2) from the coordinator, and may optionally transmit an acknowledgment (ACK) to the coordinator on the control channel.
Step 67: The first station stops transmitting the control message (e.g., C1) on the control channel.
Step 68: The third station begins transmitting data on the data channel.

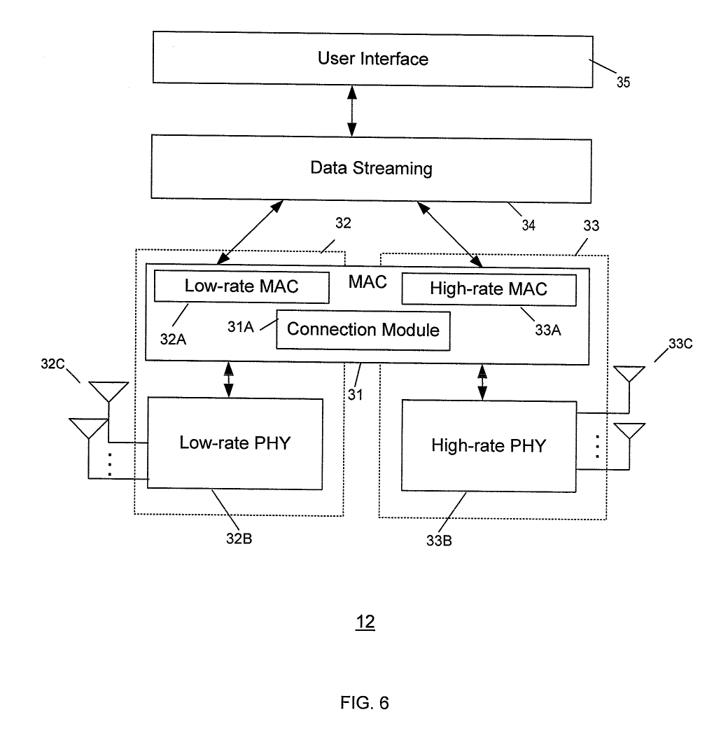

FIG. 6 shows an example block diagram of an architecture for a wireless station 12 (e.g., stations A, B, X, Y and coordinator CR described above). The station 12 includes a MAC layer 31 comprising a low-rate (LR) MAC layer 32A for managing a LR PHY layer 32B, and a high-rate (HR) MAC layer 33A for managing a HR PHY layer 33B. Together, the LR MAC layer 32A and the LR PHY layer 32B form a control communication module 32 for control message communication on a control channel 16 such as a low-rate wireless communication channel. Further, together, the HR MAC layer 33A and the HR PHY layer 33B form a data communication module 33 for data communication on a data channel 18 (e.g., 60 GHz) using a high-rate wireless communication channel.

The MAC layer 31 further include a communication module 31A which implements the connection setup processes described hereinabove (e.g., FIGS. 3-5) according to the present invention. For infrastructure mode, the coordinator and the stations each include a connection module 31A. A data streaming module 34 may be included for transmitting data streams such as audio/visual (AV) streams on the data channel. A user interface layer 35 may also be included for displaying status to a user to receiving user commands.

The LR PHY 32B and the HR PHY 33B can be in-band (e.g., both using 60 GHz) or out-of-band (e.g., HR PHY 33B is on 60 GHz and the LR PHY 32B is on WLAN, Bluetooth, 60 GHz, etc.). The HR PHY 33B includes multiple antennas 33C, and the LR PHY 32B can have one or multiple antennas 32C. In one example, the communication module 33 provides a MAC/PHY path for the data communication over an in-band channel, and the communication module 32 provides a MAC/PHY path for control message communication over an out-of-band channel. Specifically, the communication module 32 implements out-of-band communication for control transmission via an antenna 32C on an LR out-of-band channel 16. The communication module 33 implements an in-band communication for transmission of information (e.g., data, video, audio, etc.) via the antennas 33C on an HR in-band channel 18. The communication module 33 includes a HR MAC/PHY path for the in-band data channel 18 (e.g., a 60 GHz frequency band). The HR PHY layer 33B supports directional (or beamformed/steered) wireless communication on the in-band channel 18. The communication module 32 comprises a LR MAC/PHY path for the out-of-band channel 16 (e.g., Bluetooth, UWB or WLAN, or a different 60 GHz band as used in the HR path), and supports omni-directional wireless communication over the out-of-band channel 16.

In infrastructure mode, a wireless access point (AP) provides a coordination function by forwarding data and control messages for the wireless stations, enabling the wireless stations to establish connections with each other via communication links through the access point. A station can transmit an information request to the access point to obtain the information about other stations within a communication system such as a wireless network. Wireless stations can periodically receive control messages such as beacons from the access point, wherein the beacons indicate channel reservation and occupation information, allowing the stations to reserve a data channel based on such information. Further, a channel reservation scheme may be applied to a wireless channel (out-of-band channel and/or in-band channel) based on a superframe structure including superframes separated by beacons. In a contention-free period (CFP), time scheduling is utilized, wherein beacons provide information about scheduled channel time blocks. Reserving a channel includes reserving channel bandwidth for communication during a reserved period. For example, a bandwidth reservation scheme is applied based on the superframe structure, wherein beacons divide the channel time into multiple superframes. In each superframe there are contention periods and CFPs. In each CFP there are one or more schedules, wherein each schedule includes one or more reserved channel time blocks reserved for a requested transmission. The schedules represent reserved channel time block periods, and the time periods between the schedules are unreserved channel time blocks. The length of each reserved channel time block is defined in a schedule for a pair of stations. In one example, a beacon can include bandwidth allocation information elements (IE), indicating channel occupation information (e.g., certain duration of a channel time block is reserved for communication).

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of wireless communication, comprising:
establishing a wireless connection by reserving a wireless data channel for data communication;
upon completion of said data communication, maintaining the data channel reserved and indicating the data channel is unoccupied.

2. The method of claim 1 further including the step of:
while the data channel remains reserved and unoccupied, establishing another wireless connection for data communication on the data channel, by maintaining the data channel reserved and indicating that the data channel is occupied.

3. The method of claim 2, wherein the step of establishing a connection includes communication via a wireless control channel to reserve bandwidth for data communication on a wireless data channel.

4. The method of claim 3, wherein the step of maintaining the data channel reserved while indicating the data channel is unoccupied, further includes transmitting one or more control messages on the control channel indicating the data channel is reserved and unoccupied.

5. The method of claim 4, wherein establishing another connection for data communication further includes:
upon detecting one or more control messages on the control channel indicating the data channel is reserved and unoccupied, transmitting one or more control messages on the control channel indicating the data channel is reserved and occupied.

6. The method of claim 4, wherein the step of establishing a connection by reserving a wireless data channel for data communication, further includes transmitting one or more control messages on the control channel indicating the data channel is reserved and occupied.

7. The method of claim 3, wherein the data channel comprises a wireless in-band channel and the control channel comprises a wireless out-of-band channel.

8. The method of claim 3, wherein the data channel comprises a wireless in-band channel and the control channel comprises a wireless in-band channel.

9. The method of claim 2, wherein the wireless data channel comprises a 60 GHz frequency channel.

10. The method of claim 2, wherein the connections are established in ad hoc mode.

11. The method of claim 2, wherein the connections are established in infrastructure mode by exchanging control messages via a coordination function.

12. The method of claim 2, wherein the step of establishing another connection further includes establishing a connection between wireless stations for successive data channel transmissions on a reserved data channel, without requiring reserving the data channel again.

13. A wireless station, comprising:
a communication module configured for wireless communication; and
a connection module configured for establishing a wireless connection by reserving a wireless data channel for data communication via the communication module, and upon completion of said data communication, maintaining the data channel reserved and indicating the data channel is unoccupied.

14. The wireless station of claim 13, wherein the connection module is further configured such that, while the data channel remains reserved and unoccupied, the connection module establishes another wireless connection for data communication on the data channel, by maintaining the data channel reserved and indicating that the data channel is occupied.

15. The wireless station of claim 14, wherein the connection module is further configured for establishing a connection via the communication module by communicating on a wireless control channel to reserve bandwidth for data communication on a wireless data channel.

16. The wireless station of claim 15, wherein the connection module is further configured such that maintaining the data channel reserved while indicating the data channel is unoccupied includes transmitting one or more control messages on the control channel indicating the data channel is reserved and unoccupied, wherein each such control message includes a source MAC address (SA) and a destination MAC address (DA) of a peer station with which data transmission on the particular data channel recently occurred.

17. The wireless station of claim 16, wherein the communication module is further configured for establishing a connection by transmitting one or more control messages on the control channel indicating the data channel is reserved and occupied.

18. The wireless station of claim 15, wherein the data channel comprises a wireless in-band channel and the control channel comprises a wireless out-of-band channel.

19. The wireless station of claim 15, wherein the data channel comprises a wireless in-band channel and the control channel comprises a wireless in-band channel.

20. The wireless station of claim 14, wherein the wireless data channel comprises a 60 GHz frequency channel.

21. The wireless station of claim 14, wherein the connections are established in ad hoc mode.

22. The wireless station of claim 14, wherein the connections are established in infrastructure mode by exchanging control messages via a coordination function.

23. The wireless station of claim 14, wherein the connection module is further configured for establishing said other connection for successive data channel transmissions on a reserved data channel, without requiring reserving the data channel again.

24. A wireless communication system, comprising:
a first wireless station comprising a first communication module configured for wireless communication, and a first connection module configured for establishing a wireless connection by reserving a wireless data channel for data communication via the communication module, and upon completion of said data communication, maintaining the data channel reserved and indicating the data channel is unoccupied; and
a second wireless station comprising a second communication module configured for wireless communication, and a second connection module configured such that while the data channel remains reserved and unoccupied, the second connection module establishes another wireless connection for data communication on the data channel via the second communication module, by maintaining the data channel reserved and indicating that the data channel is occupied.

25. The system of claim 24, wherein the first connection module is further configured for establishing a connection via the first communication module by communicating on a wireless control channel to reserve bandwidth for data communication on a wireless data channel.

26. The system of claim 25, wherein the first connection module is further configured such that maintaining the data channel reserved while indicating the data channel is unoccupied includes transmitting one or more control messages on the control channel indicating the data channel is reserved and unoccupied.

27. The system of claim 26, wherein the second communication module is further configured for establishing said another connection for data communication by detecting one or more control messages on the control channel indicating the data channel is reserved and unoccupied, and transmitting one or more control messages on the control channel indicating the data channel is reserved and occupied.

28. The system of claim 26, wherein the first communication module is further configured for establishing a connection by transmitting one or more control messages on the control channel indicating the data channel is reserved and occupied.

29. The system of claim 25, wherein the data channel comprises a wireless in-band channel and the control channel comprises a wireless out-of-band channel.

30. The system of claim 25, wherein the data channel comprises a wireless in-band channel and the control channel comprises a wireless in-band channel.

31. The system of claim 24, wherein the wireless data channel comprises a 60 GHz frequency channel.

32. The system of claim 24, wherein the connections are established in ad hoc mode.

33. The system of claim 24, wherein the connections are established in infrastructure mode.

34. The system of claim 24, wherein the second connection module is further configured for establishing said another connection for successive data channel transmissions on a reserved data channel, without requiring reserving the data channel again.
